(19) United States
(12) Patent Application Publication
(10) Pub. No.: US 2020/0025065 A1
(43) Pub. Date: Jan. 23, 2020

(54) BRACKET

(71) Applicant: HONDA MOTOR CO., LTD., Tokyo (JP)

(72) Inventors: Azuki Ichikawa, Wako-shi (JP); Shun Tanaka, Wako-shi (JP)

(73) Assignee: Honda Motor CO.,LTD., Tokyo (JP)

(21) Appl. No.: 16/514,366

(22) Filed: Jul. 17, 2019

(30) Foreign Application Priority Data
Jul. 17, 2018 (JP) 2018-134285

(51) Int. Cl. F02B 77/08; F02M 37/00

(52) U.S. Cl. CPC F02B 77/08; F02M 37/0011

(57) ABSTRACT

A bracket includes: a fastener fixed to an engine by a fastening member; and a protector that is disposed between a high-pressure fuel pump (fuel system component) and a vehicle body frame (vehicle body component) opposed to the high-pressure fuel pump, and covers the high-pressure fuel pump continuously from the fastener. The protector includes: an inclined section that is located more upward at a position further in a direction away from the vehicle body frame; and a curved surface section that is curved between the fastener and the inclined section.

### CROSS REFERENCES TO RELATED APPLICATIONS

The present application claims priority under 35 U.S.C. § 119 to Japanese Patent Application No. 2018-134285, filed Jul. 17, 2018, entitled “Bracket.” The contents of this application are incorporated herein by reference in their entirety.

### BACKGROUND

### 1. Field

The present disclosure relates to a bracket that protects fuel system components.

### 2. Description of the Related Art

A conventional technique is known related to a bracket that protects a fuel system component, such as a high-pressure fuel pump which supplies fuel to an engine. This type of technique is described in, for example, Japanese Unexamined Patent Application Publication No. 2017-8769.

Japanese Unexamined Patent Application Publication No. 2017-8769 relates to a protective structure for engine fuel supply system components for protecting the fuel supply system components mounted on the head cover of an engine by a protector. Japanese Unexamined Patent Application Publication No. 2017-8769 describes a protector in a protective structure, the protector including: a main wall that covers the fuel supply system components in a load input direction which is a direction of an input of collision load; a fastener that is fastened to a head cover on one side in a perpendicular direction which is any direction perpendicular to the load input direction; and other end that is close to a thick-walled section of the head cover on the other side in the perpendicular direction, and has a predetermined gap between the thick-walled section and the other end. At the time of receiving a collision load, the other end comes into contact with the thick-walled section of the head cover, and supports the collision load along with the fastener.

### SUMMARY

Demands and legal regulations on safety against collision are becoming strict every year, and a bracket which protects a fuel system component such as a fuel pump requires high strength. As a method for avoiding occurrence of a situation where another vehicle body component comes into contact with a fuel system component due to collision or the like, the bracket may be provided with an inclined section, and contact between the fuel system component and the vehicle body component is avoided by sliding the inclined section. However, even in this case, the bracket requires high stiffness for receiving the load of the vehicle body component at the time of contact.

The present application describes a structure in a bracket which protects engine fuel system components, the structure making it possible to effectively avoid occurrence of a situation where a vehicle body component and a fuel system component come into contact with each other due to an external force generated at the time of collision.

(1) The present disclosure relates to a bracket (for instance, a bracket 5 described later) which protects a fuel system component (for instance, a high-pressure fuel pump 20 described later) mounted on an engine (for instance, an engine 1 described later), the bracket including: a fastener (for instance, a fastener 70 described later) fixed by a fastening member (for instance, a fastening member 90 described later); and a protector (for instance, a protector 50 described later) that is disposed between the fuel system component and a vehicle body component (for instance, a vehicle body frame 2 described later) opposed to the fuel system component, and covers the fuel system component continuously from the fastener. The protector includes: an inclined section (for instance, an inclined section 52 described later) that is located more upward at a position further in a direction away from the vehicle body component so that at least one part of the inclined portion is located in a vicinity of and faced to the vehicle body component; and a curved surface section (for instance, a curved surface section 51 described later) that is curved between the fastener and the inclined section.

Consequently, when the vehicle body component is made closer to the fuel system component due to an external force or the like, it is possible to reliably bring the vehicle body component into contact with the bracket (see FIG. 9). Also, the inclined section of the protector having a spherical surface and high stiffness makes it possible to reliably guide the vehicle body component upward and effectively avoid contact with the fuel system component. In addition, due to improvement of the stiffness of the bracket, noise and vibration can be reduced. Furthermore, when the inclined section is curved and is made wide in width and height directions, a collision object (for instance, the vehicle body component) and the inclined section are brought into contact with each other without fail. Thus, the entire object to be protected may not be covered.

(2) In the bracket described in (1), it is preferable that an inclined section upper end, which is an uppermost end of the inclined section, be positioned over a vehicle body component lower end which is a lowermost end of a portion of the vehicle body component, the portion being opposed to the bracket. The “lowermost” end of the vehicle body component is its lower portion which can first contact the bracket when the vehicle body component is forced to move toward the bracket due to an external force.

Consequently, it is possible to upwardly guide the vehicle body component moved by an external force more reliably and to avoid contact with the fuel system component more reliably.

(3) In the bracket described in (2), it is preferable that the vehicle body component lower end be positioned over an inclined section lower end which is a lowermost end of the inclined section.

Consequently, it is possible to bring the vehicle body component into contact with the inclined section more reliably, and to avoid damage to the fuel system component more reliably.

### BRIEF DESCRIPTION OF THE DRAWINGS

FIG. 1 is a perspective view, seen from a diagonally upper position, of an engine which uses a bracket according to an embodiment of the present disclosure.

FIG. 2 is an enlarged perspective view illustrating a high-pressure fuel pump as a fuel system component and a bracket which are mounted on the engine in the embodiment.

FIG. 3 is a right side view of the bracket of the embodiment.

FIG. 4 is a left side view of the bracket of the embodiment.

FIG. 5 is a back view of the bracket of the embodiment.

FIG. 6 is a plan view of the bracket of the embodiment.

FIG. 7 is a bottom view of the bracket of the embodiment.

FIG. 8 is a cross-sectional view illustrating a positional relationship between a vehicle body frame and a bracket of the embodiment.

FIG. 9 is an enlarged perspective view, seen from the backside, of the bracket fixed to the engine in the embodiment.

FIG. 10 is an enlarged perspective view, seen from the front side, of the bracket fixed to the engine in the embodiment.

### DESCRIPTION OF THE PREFERRED EMBODIMENTS

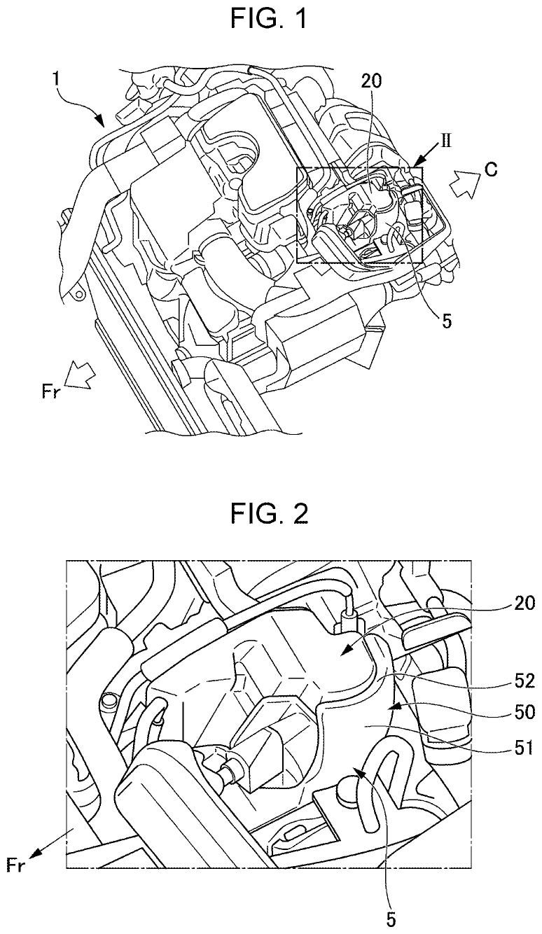

Hereinafter, a preferable embodiment of the present disclosure will be described with reference to the drawings. FIG. 1 is a perspective view, seen from a diagonally upper position, of an engine 1 which uses a bracket 5 according to an embodiment of the present disclosure.

FIG. 1 illustrates the manner in which various components, such as a high-pressure fuel pump 20, are mounted as fuel system components on the engine 1 for a vehicle. In the embodiment, an example will be described in which the engine 1 is disposed on a front Fr-side, and a vehicle cabin C is provided in back of the engine 1. Hereinafter, a description will be given under the assumption that the front, back, right, and left directions are referenced with respect to the front Fr of the vehicle as the front side for the sake of convenience.

FIG. 2 is an enlarged perspective view illustrating a high-pressure fuel pump 20 as a fuel system component and a bracket 5 which are mounted on the engine 1. FIG. 2 is an enlarged view of a rectangular area II depicted by the dashed-dotted line of FIG. 1. As illustrated in FIG. 2, the high-pressure fuel pump 20 mounted on the engine 1 is covered by the bracket 5.

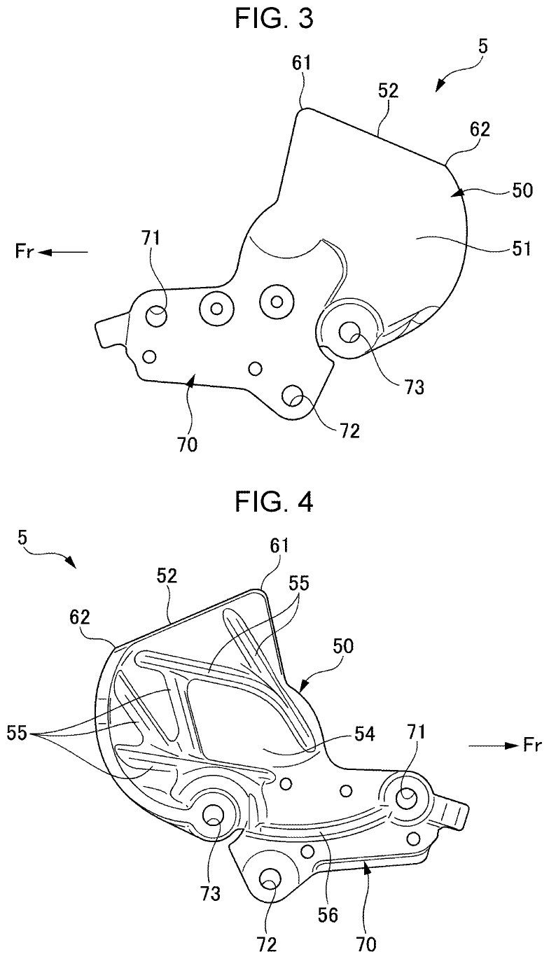

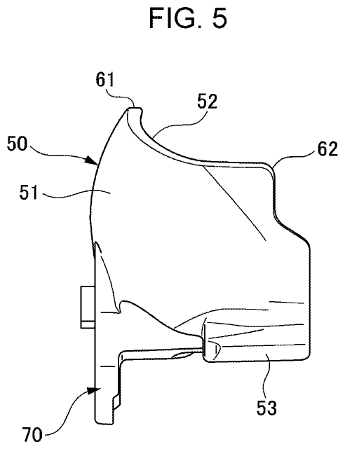

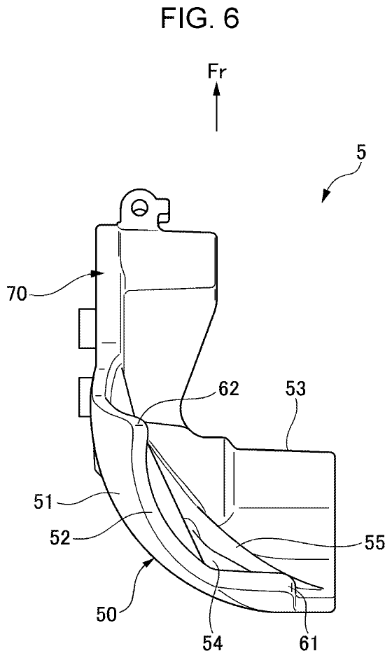

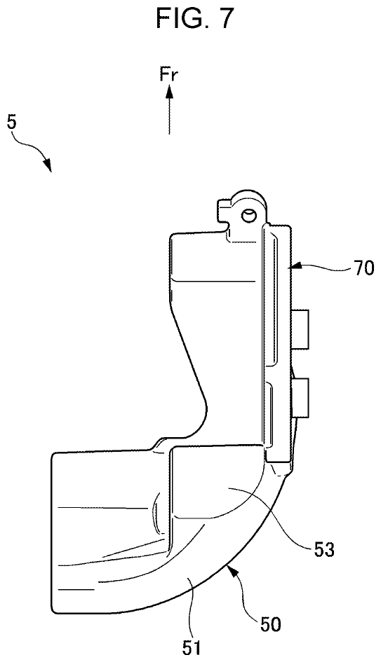

Next, the structure of the bracket 5 itself will be described. FIG. 3 is a right side view of the bracket 5 of the embodiment, FIG. 4 is a left side view of the bracket 5, FIG. 5 is a back view of the bracket 5, FIG. 6 is a plan view of the bracket 5, and FIG. 7 is a bottom view of the bracket 5.

As illustrated in FIGS. 3 to 7, as the primary components, the bracket 5 of the embodiment includes a protector 50 that covers the high-pressure fuel pump 20, and a fastener 70 that is fixed to the engine 1 as a support portion.

In the protector 50, a curved surface section 51 is formed which bulges outward. The curved surface section 51 has a shell structure in which the opposite side to the side facing the high-pressure fuel pump 20 to be protected bulges spherically. An inclined section 52 is formed at an upper portion of the curved surface section 51 of the protector 50.

The inclined section 52 constitutes an upper portion of the protector 50. Hereinafter, let an inclined section upper end 61 be the uppermost end of the inclined section 52, and an inclined section lower end 62 be the lowermost end of the inclined section 52. The inclined section upper end 61 is positioned on the front side. The inclined section lower end 62 is positioned on the back side, and is a portion overlapping with the curved surface section 51. As illustrated in FIGS. 3 and 4, the inclined section 52 is inclined downward from the front to the back in a side view. As illustrated in the back view of FIG. 5 and the plan view of FIG. 6, the inclined section 52 extends from the front to the back, then is curved to one side in a right-left direction (the right side on the paper surface of FIGS. 5 and 6). In this manner, the inclined section 52 positioned at an upper portion of the protector 50 has a shape which turns to one side in the right-left direction while reducing its height gradually as the inclined section 52 extends from the front to the back.

As illustrated in FIG. 7, a plate-shaped bottom wall section 53 is formed at a lower portion of the protector 50. The protector 50 is connected to the fastener 70. The fastener 70 and the protector 50 are continuously connected with the same material, and form an integral member. The fastener 70 itself is formed in an elongated plate shape extending in a front-back direction.

In the fastener 70, multiple fastening holes 71, 72, and 73 at intervals are formed in the front-back direction. A fastening member, such as a bolt, described later is inserted in and fastened to these fastening holes 71, 72, 73, and the bracket 5 is thereby fixed to the engine 1. The fastener 70 has a cantilever support structure for the bracket 5.

As illustrated in FIG. 4, multiple ribs 55 and 56 are formed on the back surface 54 of the bracket 5. The ribs 55 are positioned at a concave-shaped portion located on the back side of the curved surface section 51 on the back surface 54.

The ribs 55 are each formed in a substantially linear shape or a substantially circular arc shape, and have different extending directions. For instance, each rib 55 is formed in a shape along the end face of the protector 50 or in a direction crossing the direction of inclination of the inclined section 52. In addition, some of the multiple ribs 55 are joined or crossed. The rib 56 is formed in a substantially circular arc shape so as to connect the fastening hole 71 and the fastening hole 73 on the back surface 54.

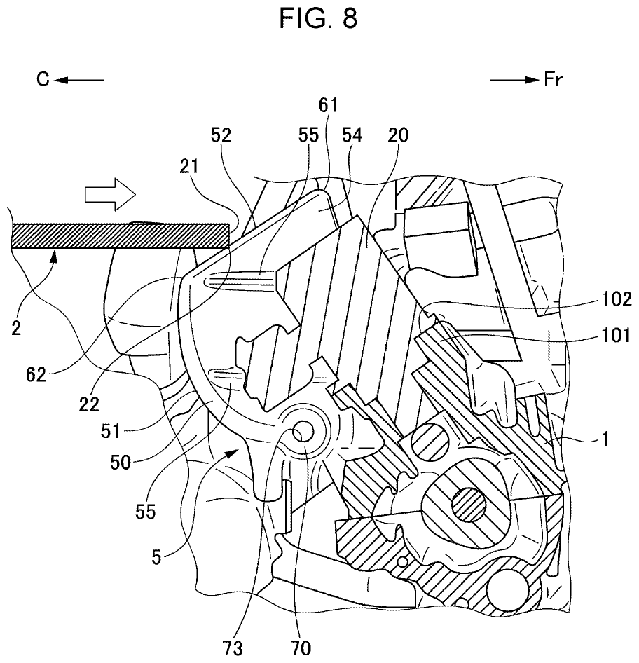

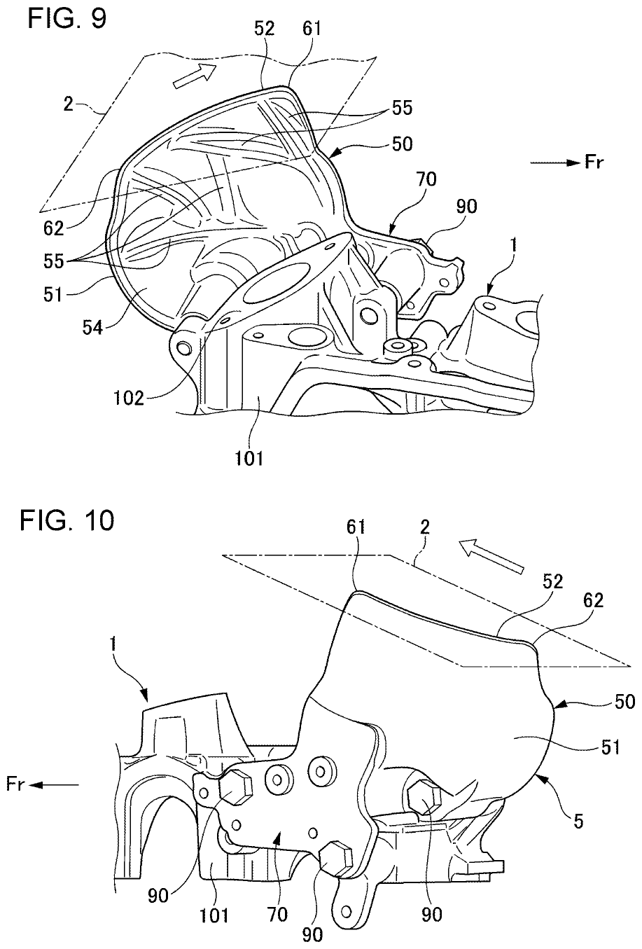

Next, the arrangement of the bracket 5 will be described. FIG. 8 is a cross-sectional view illustrating a positional relationship between a vehicle body frame 2 and the bracket 5 of the embodiment. FIG. 9 is an enlarged perspective view, seen from the backside, of the bracket 5 fixed to the engine 1 in the embodiment. FIG. 10 is an enlarged perspective view, seen from the front side, of the bracket 5 fixed to the engine 1 in the embodiment. It is to be noted that in FIGS. 9 and 10, the high-pressure fuel pump 20 is not illustrated.

As illustrated in FIG. 8, a seating face 102 for mounting the high-pressure fuel pump 20 is formed in a pump fixed section 101 of the engine 1. The high-pressure fuel pump 20 is positioned near a back surface 54 of the bracket 5, and is covered by the protector 50 of the bracket 5. As illustrated in FIGS. 9 and 10, the bracket 5 is fixed to the pump fixed section 101 by a fastening member 90.

The vehicle body frame 2 is provided as a vehicle body component on the side of the vehicle chamber C in the front-back direction of the high-pressure fuel pump 20. The vehicle body frame 2 is opposed to the high-pressure fuel pump 20 with the bracket 5 interposed therebetween. A front end 21 of the vehicle body frame 2 is a portion opposed to the high-pressure fuel pump 20 which is at a position in contact with or is positioned in the vicinity of the inclined section 52 of the bracket 5.

Let a vehicle body frame lower end 22 be the lowermost end of the front end 21 of the vehicle body frame 2. Arrangement is set so that the vehicle body frame lower end 22 is at a position lower than the inclined section upper end 61 of the bracket 5 and at a position higher than the inclined section lower end 62. Therefore, even when the vehicle body frame 2 is moved in the direction indicated by a white arrow of FIG. 8 due to an external force, the vehicle body frame 2 is brought into contact with the inclined section 52 of the bracket 5 without fail, thus movement of the vehicle body frame 2 to the side of the high-pressure fuel pump 20 is prevented.

As illustrated by the dashed-dotted line of FIGS. 9 and 10, the vehicle body frame 2, which is made closer to the high-pressure fuel pump 20 by an external force or the like, is guided diagonally forward by the inclined section 52 of the bracket 5, and contact between the vehicle body frame 2 and the high-pressure fuel pump 20 is avoided.

According to the embodiment described above, the following effects are achieved. The bracket 5 of the embodiment includes the fastener 70 fixed to the engine 1 by the fastening member 90, and the protector 50 that is disposed between the high-pressure fuel pump (fuel system component) 20 and the vehicle body frame (vehicle body component) 2 opposed to the high-pressure fuel pump 20, and covers the high-pressure fuel pump 20 continuously from the fastener 70. The protector 50 includes the inclined section 52 that is located more upward at a position further in a direction away from the vehicle body frame 2, and the curved surface section 51 that is curved between the fastener 70 and the inclined section 52.

Consequently, when the vehicle body frame 2 is made closer to the high-pressure fuel pump 20 due to an external force or the like, it is possible to reliably bring the vehicle body frame 2 into contact with the bracket 5. Also, the inclined section 52 of the protector 50 having a spherical surface and high stiffness makes it possible to reliably guide the vehicle body frame 2 upward and effectively avoid contact with the high-pressure fuel pump 20. In addition, due to improvement of the stiffness of the bracket 5, noise and vibration can be reduced. Furthermore, when the inclined section 52 is curved and is made wide in width and height directions, a collision object (for instance, the vehicle body frame 2) and the inclined section 52 are brought into contact with each other without fail. Thus, the entire object to be protected may not be covered.

In addition, in the bracket 5 of the embodiment, the inclined section upper end 61, which is the uppermost end of the inclined section 52, is positioned over the vehicle body frame lower end 22 which is the lowermost end of the front end 21 that is a portion of the vehicle body frame 2, the portion being opposed to the bracket 5.

Consequently, it is possible to upwardly guide the vehicle body frame moved by an external force more reliably and to avoid contact with the high-pressure fuel pump 20 more reliably.

Furthermore, in the bracket 5 of the embodiment, the vehicle body frame lower end 22 is positioned over the inclined section lower end 62 which is the lowermost end of the inclined section 52.

Consequently, at the time of collision, it is possible to bring the vehicle body frame 2 into contact with the inclined section 52 more reliably, and to avoid damage to the high-pressure fuel pump 20 more reliably.

Although a preferable embodiment of the present disclosure has been described above, the present disclosure is not limited to the above-described embodiment, and modifications may be made as appropriate.

Although the bracket 5 is fixed to the engine 1 in the above-described embodiment, the bracket 5 may be fixed to another member other than the engine 1.

Although a vehicle has been described as an example in which the engine is disposed on the front Fr-side in the embodiment, the present disclosure is applicable to a vehicle in a different configuration for mounting the engine, such as a vehicle in which the engine is disposed on the rear side.

Although a high-pressure fuel pump is used as an example of the fuel system component in the embodiment, the fuel system component is not necessarily limited to this. The bracket of the present disclosure makes it possible to protect a pipe such as a delivery pipe that delivers fuel, an injector, a purge solenoid valve (PCS), a canister and the like as the fuel system components.

What is claimed is:

1. A bracket which protects a fuel system component mounted on an engine, the bracket comprising:
a fastener fixed to a fastening member which supports the bracket; and
a protector disposed between the fuel system component and a vehicle body component which is faced to the fuel system component, the protector continuously extending from the fastener so as to cover the fuel system component, thereby protecting the fuel system component from the vehicle body component,
wherein the protector comprises
an inclined section located in a vicinity of the vehicle body component and extending upward in a direction away from the vehicle body component, and
a curved surface section extending with a curvature between the fastener and the inclined section.

2. The bracket according to claim 1,
wherein the inclined section comprises an uppermost end and a lower end at which a lower portion of the vehicle body component is faced to the bracket, the uppermost end of the inclined section being higher than a lowermost part of the lower portion of the vehicle body component.

3. The bracket according to claim 2,
wherein the lower portion of the vehicle body component is positioned above a lowermost end of the inclined section.
